(19) United States
(12) Patent Application Publication
(10) Pub. No.: US 2010/0023300 A1
(43) Pub. Date: Jan. 28, 2010

(54) SENSOR BASED MONITORING OF SOCIAL NETWORKS

(75) Inventors: Michael Farry, Belmont, MA (US); Jonathan Pfautz, Carlisle, MA (US); Samuel Madden, Cambridge, MA (US)

Correspondence Address: BARLOW, JOSEPHS & HOLMES, LTD., 101 DYER STREET, 5TH FLOOR, PROVIDENCE, RI, 02903, US

(73) Assignee: CHARLES RIVER ANALYTICS, INC., Cambridge, MA (US)

(21) Appl. No.: 12/510,299

(22) Filed: Aug. 20, 2009

Related U.S. Application Data
(60) Provisional application No. 61/084,108, filed on Jul. 28, 2008.

(51) Int. Cl. G06F 17/18; G06F 15/00

(52) U.S. Cl. 702/181; 702/188

(57) ABSTRACT

A method and system for detecting and monitoring discrete interactions within a physical social network is provided. The system and method detects attributes associated with human communication activities and distinguishes them from other concurrently detected activities in order to identify discrete interactions that are in turn transmitted across a network having a limited data rate. Generally, in its simplest form a plurality of wireless sensors are deployed across a cross-section of people of interest. Once deployed, the wireless sensors establish an ad-hoc network that transmits a small amount of data relating to the each of the discrete individuals bearing a sensor. The collected data is analyzed through the application of rules set forth in a Bayesian belief network to make a determination regarding the probability that an actual interaction between two individuals bearing sensors in fact occurred.

### CROSS-REFERENCE TO RELATED APPLICATIONS

This application is related to and claims priority from earlier filed U.S. Provisional Patent Application No. 61/084,108, filed Jul. 28, 2008.

### BACKGROUND OF THE INVENTION

The present invention relates generally to a method and system for detecting and monitoring discrete interactions within a social network. More specifically, the present invention relates to a system and method whereby sensors are deployed and used to detect human communication activities and distinguish them from other activities in order to identify discrete interactions that are in turn transmitted across a network having a limited data rate.

As communication and interaction around the world has dramatically increased due to the availability of reliable and inexpensive modes of travel and channels of communication, such as the Internet, it has been discovered that large and wide spread social networks have developed wherein each user, defined as a node, forms a sprawling web of contacts or interactions. In this regard, the Internet has connected the world with literally billions of interrelated nodes while many applications such as the World Wide Web, online bulletin boards, email, online instant messaging and peer-to-peer solutions allow organization of and direct contact between any number of these nodes.

While observation and monitoring of these sprawling networks provide large amounts of information relating to the interaction between humans, on a smaller scale, the observation of the interactions of smaller groups of people, such as teenagers interacting in a mall, also often provides highly useful information. For example, the detection of the frequency, length and intensity of interactions between discrete individuals in such environments may yield information regarding gang related activities, mob incidents or even pending terrorist action.

Since there were no hard tools with which to monitor the structure and interaction within a social network, the study of these social networks was more art than science. Despite the imprecise nature of the process, such information gained in the study of social networks was still important in connection with studying, describing, and understanding the dynamic and diverse nature of human interrelationships. One method, graph theory, has been employed to perform social network analysis to develop theoretical reasoning about a network of people (defined as nodes) and their relationships (links between nodes). Graph theory has been applied, with varying levels of success, to a wide variety of domains, including the study of interpersonal (e.g., social, familial) relationships, communication networks and organizational structures. As computational technology has increased exponentially and has become available on a widespread basis, it has made it possible to expand the impact and effectiveness of social network analysis. In this regard the computational technology has taken a process that was formerly reliant on onerous data collection performed via pencil-and-paper interviewing techniques and changed it to a comparatively simple task of collecting and analyzing a variety of electronic communication (e.g., email, message boards, blog postings and the like).

While social network analysis has benefited from new technologies that capture a large volume of digitally mediated communication, new difficulties arise due to the inability to incorporate data that is obtained based on physically close, face-to-face interactions among people. As a result systems that employ only the computational data collection systems are limited in that they can only characterized the relationships that occur within the confines of the electronic media, while a clear interaction picture also requires an examination of the interactions that occur outside of the electronic domain. What is lacking is a natural weighting, preference mechanism that is automatically executed within the minds of the human participants and which is not immediately apparent on the face of such electronic analysis methods.

Having a correct analytical picture of the interaction across a real social network can be an important tool in many different fields. This is because virtually every aspect of human life, economic, social, personal and business decisions are either directly or indirectly affected by the preferences, tastes and actions of our friends, colleagues and acquaintances. This is in contrast to widely accepted economic theory in the fields of, for example, consumer purchases where it is assumed individuals make rational choices based upon the available product or service information. In actual fact, a recommendation, or an adverse comment from a close trusted acquaintance regarding a specific product will often override other factors in a commercial purchase decision, rightly or not. There are many other areas in which the opinions of respected acquaintances or even organizations can affect the decision making of individuals or organizations. Examples of just a few applications or activities in which trusted or respected contacts or recommendations play a significant role include seeking employment and filling job vacancies, investment opportunities, academic co-operation, finding accommodation or people to share accommodation with, buying and selling goods and services, arranging social/sporting functions, finding friendship, romantic and/or social relationships and so forth.

Clearly, therefore, analysis of the external factors and direct personal interactions is critical in order to create a comprehensive picture of a group's interrelationships as a whole. For example, an analysis of an organization's email patterns may not reveal the centrality of a particular expert who is only consulted via visits to his office because he is too busy to answer all of his emails. Similarly, co-workers may well have meaningful (and workplace-sensitive) conversations over lunch that they would not over corporate email. Providing the capability to accurately and easily capture these natural, unmediated types of communication will greatly extend the descriptive and representational power of social network analysis techniques.

There is therefore a need for a system and method of detecting and monitoring discrete interactions within a social network. Further, there is a need for a system and method whereby human communication activities are detected and distinguished from other activities to identify discrete interactions that are in turn transmitted across a network having a limited data rate.

### BRIEF SUMMARY OF THE INVENTION

In this regard, the present invention provides for a method and system for detecting and monitoring discrete interactions within a social network. Within the scope of the system and method of the present invention, physical attributes associated with human communication activities are detected and distinguished from other concurrently detected activities in order to identify discrete interactions that are in turn transmitted across a network having a limited data rate. Generally, in its simplest form the present invention provides for a plurality of wireless sensors to be deployed across a cross-section of people of interest. Once deployed, the wireless sensors establish an ad-hoc network that transmits a small amount of data relating to the each of the discrete individuals bearing a sensor. The collected data is analyzed through the application of rules set forth in a Bayesian belief network to make a determination regarding the probability that an actual interaction between two individuals bearing sensors in fact occurred.

Generally, it is preferred that the sensors in connection with the system of the present invention are of a relatively small scale. In the context of the present invention the term relatively small is intended to indicate a sensor that can be deployed without detection by the people of interest. Currently, the present invention is implemented thought he use of Berkley motes although further miniaturization is being developed with the ultimate goal of the formation of effective deployable sensors on a nano-scale wherein each sensor is the size of a grain of sand or even dust.

Once deployed, the sensors wirelessly establish an ad-hoc network wherein the data stream associated with the each of the addressable sensors is transmitted until it reaches a base station for collection and analysis. Analysis is performed by making a comparison between a sensor data set and each of the other sensor data sets using a Bayesian belief network to determine the probability that an interaction is occurring between any two given sensors. For example, if the comparative data shows that any two sensors are indicating a high proximity relative to one another, a high sound level and a correlation between both the light and temperature readings, the probability that an interaction is occurring is 100%. Similarly, if the sound is medium but the proximity is low, the rules establish that there is 34.5% probability of interaction. Empirical testing of the method and system of the present invention has shown that the method and system detects interactions with a confidence level of over 85%.

It is therefore an object of the present invention to provide a system and method of detecting and monitoring discrete interactions within a social network. It is a further object of the present invention to provide a system and method whereby human communication activities are detected and distinguished from other activities to identify discrete interactions that are in turn transmitted across a network having a limited data rate.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of a modular interface system mounted on a firearm;

FIG. 2 is a front, exploded perspective view of a modular interface system;

FIG. 3 is a diagrammic front view of a modular interface, with a bottom handguard attached; and

FIGS. 4-7 are illustrations showing various views related to the required retrofit members for mounting additional accessories to the modular interface system.

### DETAILED DESCRIPTION OF THE INVENTION

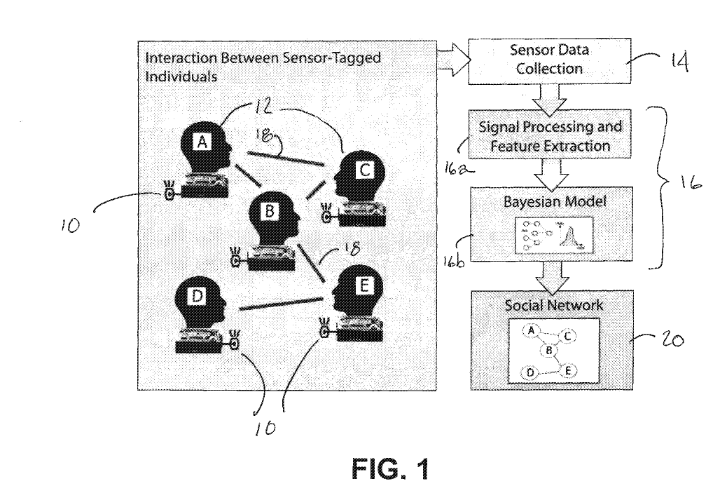

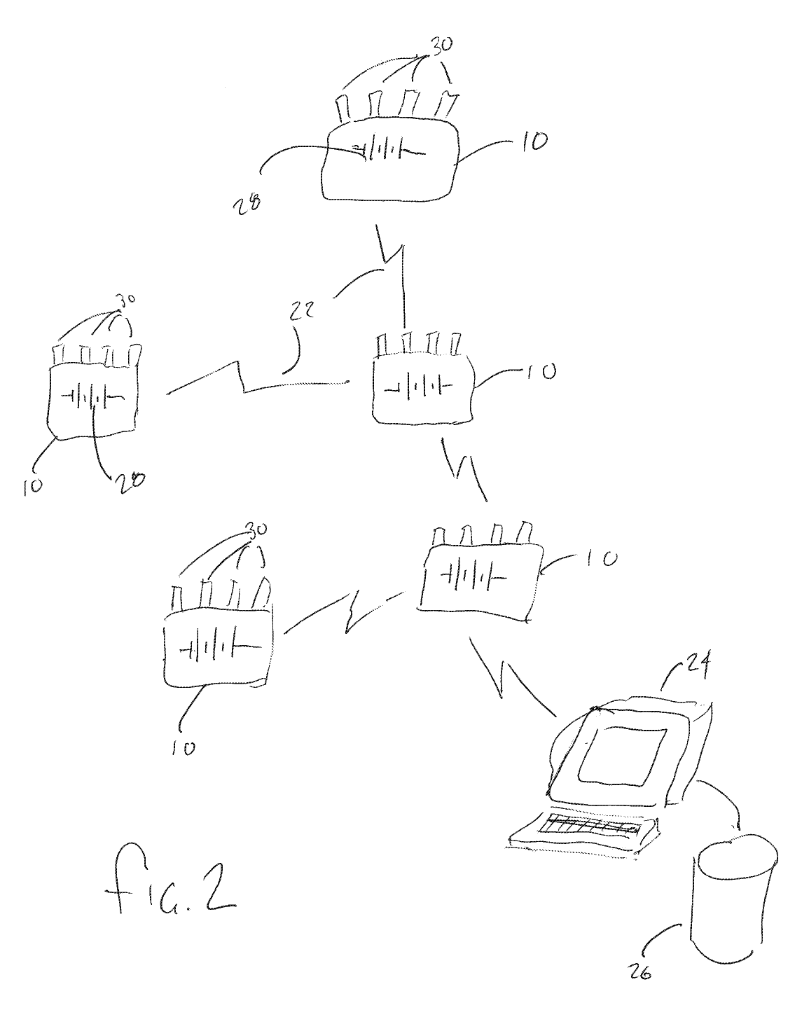

Now referring to the drawings, the method and system for detecting and monitoring discrete interactions within a social network is generally shown and illustrated in the figures. In the preferred embodiment, the system of the present invention is implemented in the form of a low power, wireless sensor-based system that is deployed in a manner that tracks relationships and interactions over time in a community of people. Turning now to FIG. 1, the system of the present invention can be seen generally to employ a plurality of sensor nodes 10 deployed across a group of people 12 to be monitored, a wireless network is established in an ad hoc basis across the plurality of sensor nodes 10, a data polling system 14 for collection of the data from the sensor nodes 10 and an analysis system 16 for reviewing the data collected from the sensor nodes 10 to determine when and where interactions 18 occurred within the group of people 12 to be monitored thereby identifying those interactions 20 for further analysis. As can be further seen in FIG. 2, the sensor nodes 10 communicate via a wireless ad hoc network 22. Additionally, the system can be seen to include a computer processor 24 and data storage device 26 for operation of the data collection and analysis process as will be described in more detail below.

Still referring to FIG. 2, the sensor node 10 used in connection with the system of the present invention is a very small, unobtrusive, low-power wireless sensor node with a limited set of sensor modalities. It is preferred that the sensor nodes 10 in connection with the system of the present invention are of a relatively small scale. In the context of the present invention the term relatively small is intended to indicate a sensor that can be deployed without detection by the people to be monitored. Currently, the present invention is implemented thought the use of Berkley motes although further miniaturization is being developed with the ultimate goal of the formation of effective deployable sensors on a nano-scale wherein each sensor is the size of a grain of sand or even dust. In addition, the sensor nodes 10 may include an on-board power supply 28 that may last several hours to several days. It is also possible that the sensor nodes 10 derive their power via radio frequency energy that is also being used to establish the ad-hoc network 22 itself.

In this manner the system uses a minimal set of sensors 30 positioned on a plurality of sensor nodes 10 and the lowest possible data rates needed to reliably identify which groups of people are interacting without explicit knowledge of people's absolute location or the exact words or phrases used in their conversations. By extracting data at very low rates, the sensor network can persist for days or weeks without needing its batteries replaced. Preferably, the wireless sensor nodes 10 are equipped with light, temperature, proximity, x-axis accelerometer, y-axis accelerometer, and sound sensors 30 that are sampled a few times per second. It should be appreciated that while the preferred mode of the present invention may include a sensor 30 to transmit each of the discrete data elements identified above, the present invention can also be fully enabled by using only a subset of sensors 30 to provide a portion of the above identified data items. To further reduce the bandwidth required to transmit the above data as it is collected, the data sensed by the sensors 30 and/or data transmitted is not full range. In other words, the data collected/and or transmitted by the sensors 30 through the sensor nodes 10 is limited to a subset of the spectrum such as high, medium and low. The sensor nodes 10, once deployed establish an ad hoc network 22 wherein each sensor node 10 becomes a network node as well as a repeater such that collected data is transmitted from sensor node 10 to sensor node 10 until it reaches a data collection point preferably at the computer processor 24.

The data polling system 14 that is employed for extracting the data from the sensor nodes 10 is preferably a data base system. More preferably, the system employs the power-efficient TinyDB database system for extracting data from a wireless sensor network although any other suitable data polling system that is now available or becomes available at a later date would be equally suitable if adapted to operate over the sensor network. The data polling system 14 facilitates collection of the data through the construction of SQL-like queries of the network 22 that request the value of each of the sensor nodes 10 sensor 30 attributes several times per second.

Once the data has been extracted from the sensor nodes 10, the system applies an analysis algorithm 16 to determine to a probabilistic certainty that an interaction occurred based on analysis of the data extracted from the sensors 30. In the preferred embodiment the analysis system 16 consists of two layers. The first layer is a data cleaning and feature extraction layer 16a that preprocesses the extracted data for analysis. The second layer is a modeling and inference layer 16b that uses a probabilistic model to predict whether two people are interacting given a set of time series data representing recent readings from their respective sensor nodes 10. For modeling, the system employs a Bayesian Belief Network (BBN), which employs a rule set that maximizes the ability of our system to predict and identify interactions.

The general purpose of the first data cleaning and feature extraction layer 16a is to compute the level of similarity in the signals collected from any two given sensor nodes 10 on the network 22. This layer 16a then predicts that a human-to-human interaction 18 may have occurred between these two sensors nodes 10 based on the fact that the two sensor nodes 10 returned similar signal characteristics. In other words, similarity metrics are applied to compare signals from the same sensor 30 modalities (e.g. sound, light, temperature) on different sensor nodes 10 to determine that a high degree of similarity between sensor 30 signal values over time is indicative that an interaction 18 occurred. For example, the changes in light levels recorded by the light sensor 30 on two sensor nodes 10 are similar should two people who are interacting walk under the same streetlamp.

It must be noted that the temporal nature of the data is important. If a pair of individuals is interacting at time t, it is likely that they are also interacting at time (t+1). It is also reasonable to assert that a meaningful interaction between two people should last for a reasonably long amount of time (i.e., short interactions where people pass each other in the hallway and greet each other are negligible.) Thus the predictive model must smooth out the interaction prediction over time by avoiding rapid switching between inferring that there is and is not an interaction. The duration of a predicted interaction should match the duration of an observed interaction. Thus using the streetlamp example above, if two sensor nodes 10 undergo the same changes in light levels at different times, those two people may have passed under the same streetlamp but were not likely interacting because they were not temporally proximate. Similarly, if those two sensor nodes undergo 10 the same changes in light levels at the same time those two people likely passed under the same streetlamp while interacting.

Once the data is collected by the data cleaning and feature extraction layer 16a, analysis as to the likelihood of an interaction is performed by making a comparison between the sensor data set and each of the other sensor data sets collected from sensor nodes 10 that were found to have similarities based on application of the first analysis layer above. In this manner, the modeling layer 16b employs a BBN to determine the probability that an interaction is occurring between any two given sensor nodes 10. Each piece of evidence that similarity exists between two sensor nodes 10 is provided to the BBN and the BBN calculates a belief about whether the two individuals under consideration are interacting for any given combination of similarity metric values. For instance, if the similarity metrics comparing light, temperature, 2D acceleration, sound, and proximity all give evidence that there is high similarity between the two compared sensor nodes, we are given a certain probability x as shown below:

P(Interaction|Light=High, Temp=High, AccelX=High, AccelY=High, Sound=High, Prox=High)=x

Accordingly, for each combination of possible states for light, temperature, accel-x, accel-y, sound, proximity and timing, an entry in the conditional probability table needs to be created. The conditional probability table is then build rule by rule until each possible combination is exhausted. An abbreviated example of such a conditional probability table is shown below:

| Light | Temp | AccelX | AccelY | Sound | Prox | P(IXN) |
|---|---|---|---|---|---|---|
| Low | Med | Med | Med | Low | High | 100.00% |
| Low | Low | Low | Low | High | Low | 100.00% |
| Med | Low | Low | Med | High | High | 93.79% |
| Med | Med | Med | Med | High | Med | 77.50% |
| Med | Med | Med | Med | High | High | 63.18% |
| Med | Low | Low | Low | High | Low | 34.54% |
| Med | Low | Low | Low | Med | Low | 25.71% |
| High | High | High | High | High | Low | 24.25% |
| Miss | Miss | Miss | Miss | Miss | Low | 14.50% |

The application of a BBN in conjunction with the conditional probability table is then employed to detect the presence of an interaction. As with the computation of similarity metrics, the BBN structure compares the processed and binned similarity metrics pair wise across all sensor nodes. Using these similarity metrics for all sensor modalities, as well as its belief about interaction in the previous time frame, the BBN produces a belief (i.e., a true/false value and an associated probability) about whether an interaction in the current timeframe.

Given a set of sensor readings, the conditional probability table is entered to determine the probability that that information indicates an interaction. For example, if the comparative data shows that any two sensor nodes 10 are indicating a high proximity relative to one another, a high sound level and a correlation between both the light and temperature readings, the probability that an interaction is occurring is 100%. Similarly, if the sound is medium but the proximity is low, the rules establish that there is 34.5% probability of interaction. Empirical testing of the method and system of the present invention has shown that the method and system detects interactions with a confidence level of over 85%.

It can therefore be seen that the present invention provides a system and method of detecting and monitoring discrete interactions within a social network using small wireless sensors via an ad-hoc network. Further, the system and method of the present invention detects and distinguishes human communication activities relative to other activities to identify discrete interactions that are in turn transmitted across a network having a limited data rate. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A system for reliably predicting interactions among a plurality of people of interest, comprising:
a plurality of wireless sensor nodes deployed among said plurality of people of interest, said wireless sensor nodes each including data collecting sensors thereon, said wireless sensor nodes forming an ad hoc network;
a data polling system that operates across said ad hoc network to gather data collected by said sensors; and
an analysis algorithm that operates on said gathered data, said algorithm first comparing data collected from each of said wireless sensor nodes to determine the relative similarity in collected data from each sensor node and second applying a predictive calculation on similar sensor nodes to determine the probability that an interaction occurred.

2. The system of claim 1, wherein said sensors collect data selected from the group consisting of: light, temperature, proximity, x-axis acceleration, y-axis acceleration and sound.

3. The system of claim 1, wherein the data collected by said sensors is a limited subset of the full data range that said sensor is capable of.

4. The system of claim 3, wherein the limited subset includes data readings of high, medium and low.

5. The system of claim 1, wherein said determination of relative similarity in collected data is done periodically using temporal periods of limited duration.

6. The system of claim 1, the relative similarity in collected data from each sensor node is determined by application of similarity metrics to compare signals from the same sensor modalities on different sensor nodes to determine that a high degree of similarity between sensor signal values.

7. The system of claim 6, wherein said determination of relative similarity in collected data is done periodically using temporal periods of limited duration.

8. The system of claim 1, wherein analysis algorithm is located on a computer processor, said computer processor being a node on said ad hoc network.

9. The system of claim 1, wherein said application of a predictive calculation is application of a Bayesian Belief Network.

10. The system of claim 9, wherein the Bayesian Belief Network compares the relative similarity of the data collected from each of the sensors on each of the sensor node pairs to produce a belief about whether an interaction in the current timeframe.

11. The system of claim 10, wherein said belief is a true or false value and a probability value.

12. The system of claim 10, wherein said Bayesian Belief Network produces said belief based on sequential comparisons performed periodically using temporal periods of limited duration.

13. A system for reliably predicting interactions among a plurality of people of interest, comprising:
a plurality of wireless sensor nodes deployed among said plurality of people of interest, said wireless sensor nodes each including data collecting sensors thereon, said wireless sensor nodes forming an ad hoc network;
a computer system connected as a node on said ad hoc network, said computer system including a process and a data storage device;
a data polling system that operates on said processor and across said ad hoc network to gather data collected by said sensors and place said data onto said storage device; and
an analysis algorithm on said computer processor that operates on said gathered data, said algorithm first comparing data collected from each of said wireless sensor nodes to determine the relative similarity in collected data from each sensor node and second applying a predictive calculation on similar sensor nodes to determine the probability that an interaction occurred.

14. The system of claim 13, wherein said sensors collect data selected from the group consisting of: light, temperature, proximity, x-axis acceleration, y-axis acceleration and sound.

15. The system of claim 13, wherein the data collected by said sensors is a limited subset of the full data range that said sensor is capable of.

16. The system of claim 15, wherein the limited subset includes data readings of high, medium and low.

17. The system of claim 13, wherein said determination of relative similarity in collected data is done periodically using temporal periods of limited duration.

18. The system of claim 13, the relative similarity in collected data from each sensor node is determined by application of similarity metrics to compare signals from the same sensor modalities on different sensor nodes to determine that a high degree of similarity between sensor signal values.

19. The system of claim 18, wherein said determination of relative similarity in collected data is done periodically using temporal periods of limited duration.

20. The system of claim 13, wherein said application of a predictive calculation is application of a Bayesian Belief Network.

21. The system of claim 20, wherein the Bayesian Belief Network compares the relative similarity of the data collected from each of the sensors on each of the sensor node pairs to produce a belief about whether an interaction in the current timeframe.

22. The system of claim 21, wherein said belief is a true or false value and a probability value.

23. The system of claim 21, wherein said Bayesian Belief Network produces said belief based on sequential comparisons performed periodically using temporal periods of limited duration.
